(19) United States
(12) Patent Application Publication
(10) Pub. No.: US 2021/0359358 A1
(43) Pub. Date: Nov. 18, 2021

(54) BATTERY CELL TRAY

(71) Applicant: McLaren Automotive Limited, Woking (GB)

(72) Inventors: Sunoj Cherian George, Woking (GB); James Douglas McLaggan, Woking (GB); Elie Talj, Woking (GB)

(21) Appl. No.: 17/277,253

(22) PCT Filed: Sep. 17, 2019
(86) PCT No.: PCT/GB2019/052607

§ 371 Date: Mar. 17, 2021

(30) Foreign Application Priority Data
Sep. 18, 2018 (GB) 1815185.2

(51) Int. Cl. H01M 10/6557; H01M 50/213; H01M 10/613; H01M 10/625; H01M 10/643; H01M 10/6567

(52) U.S. Cl. CPC H01M 10/6557; H01M 50/213; H01M 10/613; H01M 2220/20; H01M 10/643; H01M 10/6567; H01M 10/625

(57) ABSTRACT

A battery cell tray comprising a main body having a plurality of holes extending therethrough from a first face to a second face, a plurality of battery cells, each cell retained in a respective hole of the main body, wherein each cell protrudes out of the main body on both the first and the second faces.

This invention relates to a cell tray for a battery and, in particular, a cell tray which supports and retains a plurality of battery cells.

Electric powered or hybrid vehicles are well known and are becoming more and more prevalent as the desire to reduce carbon emissions increases. In such vehicles, the power that can be provided by, and the weight of, the battery is vital in determining the performance of the vehicle. The power to weight ratio of the battery is therefore something that vehicle designers are trying to optimise. This can clearly be done either by increasing the power generated for a given weight or by reducing the weight for a given power output, or most likely a combination of the two.

The batteries in electric or hybrid vehicles are typically made up of a plurality of individual battery cells connected together in such a way to allow large amounts of power to be provided to drive the wheels or power other systems in the vehicle. These cells are typically provided in the form of one or more battery modules which can be electrically connected.

Battery cells have optimum operating conditions and, in particular, operating temperatures. If the battery cells are outside of these optimum conditions, then the performance of the cells can deteriorate and the power the cells can provide is reduced. Alternatively or additionally, overheating can affect the operating life and/or general reliability of the battery cells, which is also undesirable.

It is known to provide cell trays having a plurality of holes or recesses for holding battery cells. Such cell trays allow coolant fluid to circulate around parts of the battery cells, thereby providing a cooling effect to the cells as heat is transferred from the cells to the coolant. It is known to use a pair of cell trays, one supporting each end of the battery cells, with the coolant fluid being permitted to flow over the central portion of each cell, but having the cell terminals of the cells, typically located at each end of the cell, covered. It is also known to mount cells in a support structure such that the outer cylindrical surface of the cell is substantially fully enclosed by the cell holder.

According to the present invention there is provided a battery cell tray comprising a main body having a plurality of holes extending therethrough from a first face to a second face, a plurality of battery cells, each cell retained in a respective hole of the main body, wherein each cell protrudes out of the main body on both the first and the second faces.

Such a cell tray is beneficial as it permits a single cell tray to be used rather than multiple trays, one at each end of the cells, thereby minimising material usage and therefore reducing the weight of the battery module. It also permits coolant fluid to flow around a significant portion of each cell thereby maximising the cooling effect provided and allowing the battery cells to operate within the optimum temperature range.

The cells may supported by the cell tray substantially at the mid point of the cell. Each cell may have a pair of terminals, one at each end, and wherein the terminals of each cell are exposed. The cells are preferably configured in a staggered pattern across the longitudinal plane of the cell tray. Some cells may have a reversed orientation with respect to other cells.

At least one face of the main body may have a recessed portion configured to receive a resin.

The invention further provides a battery cell tray comprising a main body having a plurality of holes extending therethrough from a first face to a second face, each hole being configured to retain a battery cell, wherein at least one of the faces of the main body has a recessed portion configured to receive a resin for retaining the battery cells in the holes.

The provision of the recess portion for receiving a resin is beneficial as it enables the cells to be fixedly help in place using a simple and easy to apply resin and which, by virtue of being within a recess, does not increase to volume of the cell try. This allows the greatest amount of each cell to be exposed to coolant.

The cell tray may further comprise a plurality of battery cells. The recessed portion may extend around at least part of the end of a cell hole. Multiple recessed portions may be provided in a face, each recessed portion extending around at least part of the end of a respective cell hole.

Each cell hole may have at least one recessed portion extending around at least part of an end of the hole. The recessed portion may extend around the ends of a plurality of the cell holes. Each recessed portion may contain a resin for retaining the cells in the holes. At least one recessed portion may be provided on each face.

There may be a step change between a cell hole and a respective recessed portion. There may be a graduated change between a cell hole and a respective recessed portion.

The cells may be supported by the cell tray substantially at the mid point of the cell. Each cell may have a pair of terminals, one at each end, and wherein the terminals of each cell are exposed. The cells are preferably configured in a staggered pattern. Some cells may have a reversed orientation with respect to other cells. It is preferable that the arrangement of the reversed cells assists in allow the desired cell configuration to be achieved. The preferred cell configuration comprises 48 cells, which are arranged in 3 parallel groups of 16 cells in series. Alternative configurations may be possible, such as 2 parallel groups of 24 cells in series, or 6 parallel groups of 8 cells in series. Different total numbers of cells could be used with a suitably larger or smaller cell tray. The pattern of reversal is typically based upon trying to create the desired cell configuration in the simplest manner. This might be to reduce the length of the connections between adjacent cells in a series or it might be to keep cells of different groups either together or apart.

The cell tray may further comprise one or more flow openings within the cell tray to permit coolant flow to pass from one side of the cell tray to the other. The flow opening or openings may be larger towards the most distal part of the housing. The flow opening(s) may be provided at one end of the cell tray.

### BRIEF DESCRIPTION OF THE DRAWINGS

FIG. 1 shows a battery.

FIG. 2 shows a battery module from the front.

FIG. 3 shows a battery module from the back.

FIG. 4 shows a cell tray.

FIG. 5 shows a cell tray holding cells.

FIG. 6 shows the busbars and flexible printed circuit of a battery module.

FIG. 7 shows the cells, busbars and module terminals of a battery module.

FIG. 8 shows a close up view of one end of the cell tray of FIG. 4.

FIG. 9 shows a view of a cell tray from the opposite side to FIG. 8.

### DETAILED DESCRIPTION OF THE DRAWINGS

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Battery Overview

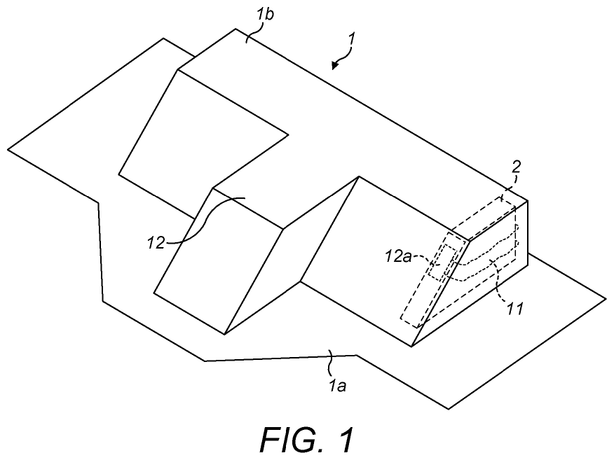

FIG. 1 shows a battery 1 which may comprise a number of identical battery modules 2. The battery modules may be arranged in a row. The battery may comprise any number of battery modules 2. In the example depicted in FIG. 1, one battery module 2 is shown for clarity, but in a preferred example there may be thirteen modules.

The battery may be installed in a vehicle. FIG. 1 shows the battery 1 fixed to a battery floor 1a. The battery floor 1a may be structurally integral to the vehicle in which the battery is installed. For example, the battery floor may be a load bearing component of a vehicle chassis. The battery floor 1a may be configured to be removably fitted to the vehicle so that the battery 1 can be removed from the vehicle. For example, for maintenance or replacement of the battery 1.

The battery 1 may further comprise a battery control unit 12 which protrudes from the row of battery modules. The battery control unit 12 may be electrically connected to one or more module control units 12a. Each battery module 2 may comprise an attached module control unit 12a. The battery control unit 12 may control each battery module control unit 12a. Each battery module control unit 12a may control the activity of the respective attached battery module. Each battery module control unit 12a may receive information concerning the operation of the respective attached battery module. The battery module control units 12a may process that information and feed that information to battery control unit 12.

The battery modules and battery control unit 12 may be enclosed by the battery floor 1a and a battery housing 1b.

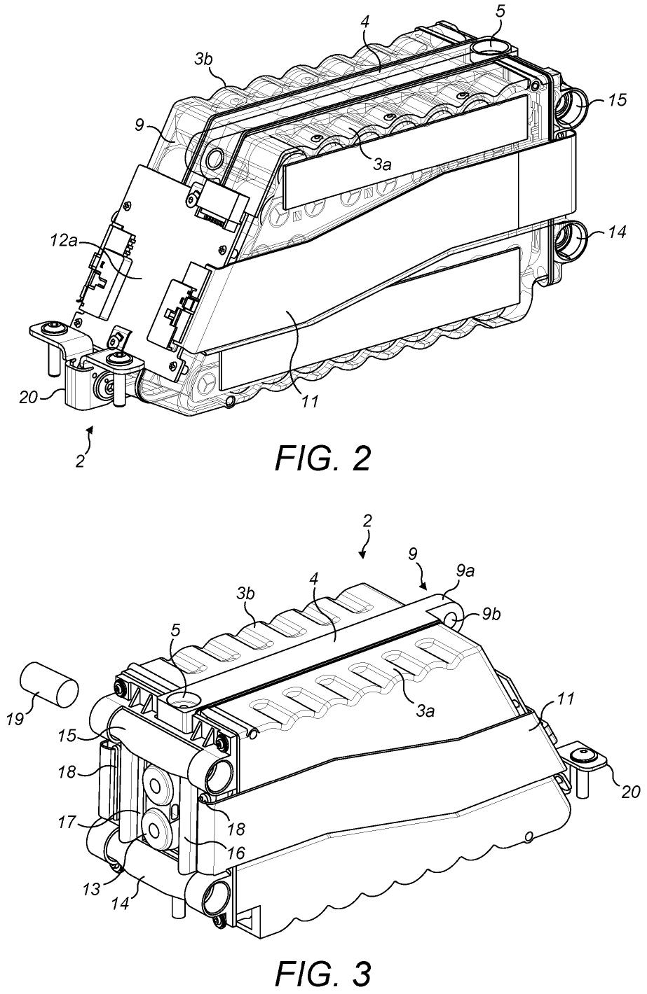

FIG. 2 shows a battery module 2 with a trapezoidal prism shape. The battery module depicted in FIG. 2 comprises a cell tray 4 and a two-part housing 3a, 3b. In FIG. 2, the battery module 2 and the cell tray 4 share a common longitudinal axis.

Cell Tray

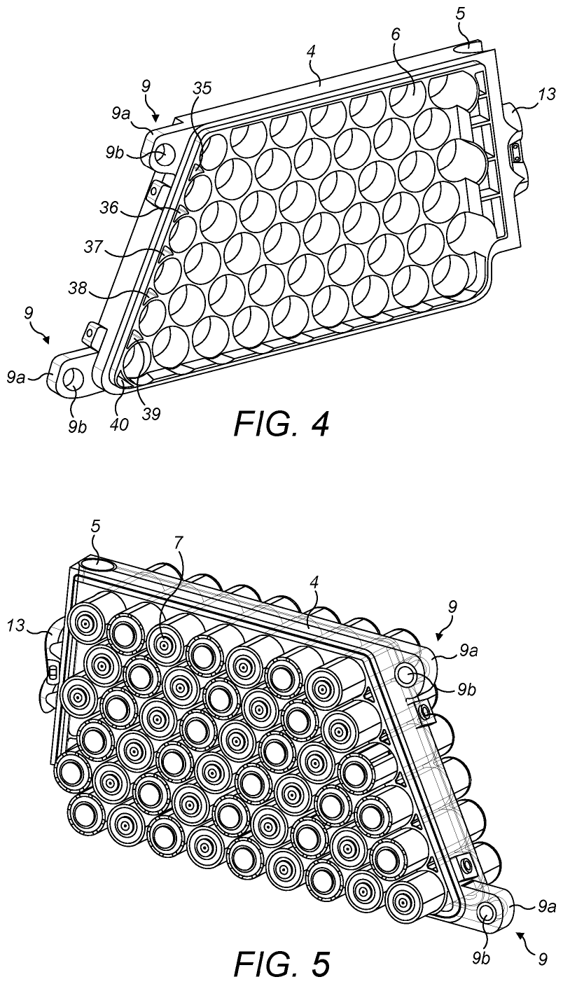

An exemplary cell tray 4 is shown in FIG. 4. The cell tray depicted in FIG. 4 comprises cell holes 6 for holding cells (not shown). Each cell hole 6 may extend through the cell tray in a direction perpendicular to the longitudinal axis of the cell tray. The cell tray may be formed of electrically insulating material.

The cell tray may further comprise a fixing hole 5 configured to receive a fixing element (not shown) for securing the cell tray 4, and hence the battery module 2, to the battery floor (not shown).

FIG. 4 shows the cell tray 4 comprising two fixings 9, each fixing comprising a tab 9a, the tab forming a connection hole 9b. Both fixings are generally positioned in the same plane as the cell tray. Each connection hole 9b may extend through its respective tab 9a in a direction parallel to the direction in which the cell holes 6 extend through the cell tray 4. The cell tray may comprise more than two fixings. The cell tray may comprise a single fixing. Fixings on multiple battery modules may receive one or more common elements so that the battery modules can be secured to one another.

FIG. 5 shows a number of cells 7 being held in the cell holes 6 of the cell tray 4. The cell tray may be configured to hold any number of cells. In the example depicted in FIG. 5 there are forty-eight cells held in respective cell holes 6. Each cell hole may hold one cell.

Resin may be poured into a recessed side of the cell tray. The resin may harden around cells placed in the cell tray so as to secure the cells in the cell tray. Alternatively, each cell 7 may be held in a cell hole 6 by an interference fit between the cell tray 4 surrounding the cell hole and the cell inserted into the respective cell hole.

Each cell hole may extend through the cell tray in a direction perpendicular to the longitudinal axis of the cell tray. In the example cell tray depicted in FIGS. 4 and 5, each cell hole is cylindrical so as to accommodate cylindrical cells. In other examples, each cell hole may be prismatic so as to accommodate prismatic cells.

The length of each cell may be greater than the length of each cell hole. Each cell 7 comprises a positive terminal and negative terminal. When a cell 7 is inserted into a cell hole 6, a length of the cell 7 comprising the positive terminal of the cell may protrude from the cell hole on one side of the cell tray 4 whilst a length of the cell 7 comprising the negative terminal protrudes from the cell hole on the other side of the cell tray. The portion of the cell 7 comprising the positive terminal and the portion of the cell 7 comprising the negative terminal may protrude from opposite sides of the cell tray. The protruding length of the portion of the cell comprising the cell's positive terminal and the protruding length of the portion of the cell comprising the cell's negative terminal may be equal.

The battery module 2 shown in FIG. 2 comprises a two-part module housing 3a, 3b. The housing 3a, 3b may form two enclosed regions which contain the cells 7 held in the cell tray 4. In FIG. 2, one part of the module housing 3a encloses the portions of cells protruding on one side of the cell tray. The second part of the module housing 3b encloses the portions of the cells protruding on the opposite side of the cell tray. In FIGS. 2 and 3, the exterior faces of the battery module 2 comprise faces of the cell tray 4 and the housing 3a, 3b. Alternatively, the housing 3a, 3b may enclose the entirety of the cell tray. In this case, the exterior faces of the battery module would comprise faces of the housing 3a, 3b.

Cell to Cell Busbars and Flexible Printed Circuit Board

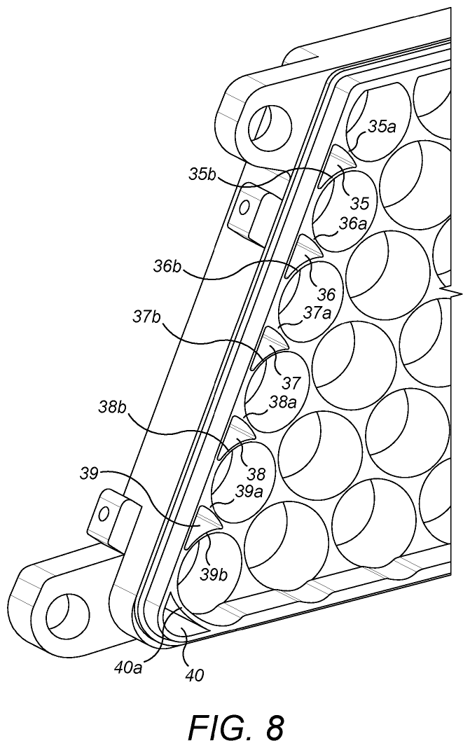

FIG. 7 shows busbars 10 contacting the terminals of multiple cells to form electrical connections between the multiple cells 7. The busbars 10 are formed of electrically conductive material. The busbars 10 may be formed of metal, for example copper or aluminium.

As above, the cell tray 4 (not shown in FIG. 7) fixedly holds cells 7, each cell having a positive terminal and a negative terminal. The busbars 10 may link the cell terminals of any number of cells.

Cells 7 may be arranged in the cell tray 4 so that positive and negative cell terminals protrude from opposite sides of the cell tray. In this way, a current flow path may be created through cells and busbars. For example, the current flow path may “snake” through the battery module. The current flow path may repeatedly intersect the cell tray. The current flow path may repeatedly intersect the longitudinal axis of the battery module. At least some of the cells may be connected in parallel by the busbars 10, meaning that the current flow path passes through multiple cells as the current flow path intersects the cell tray.

Module terminals 13 are shown in FIG. 7. The module terminals 13 are positioned on the back of the battery module and may be integral to the cell tray 4 (not shown in FIG. 7). Module terminals 13 of neighbouring battery modules may be electrically connected, for example, by module to module busbars. The module terminals 13 allow a supply of current to and/or from the cells 7 of the battery module 2.

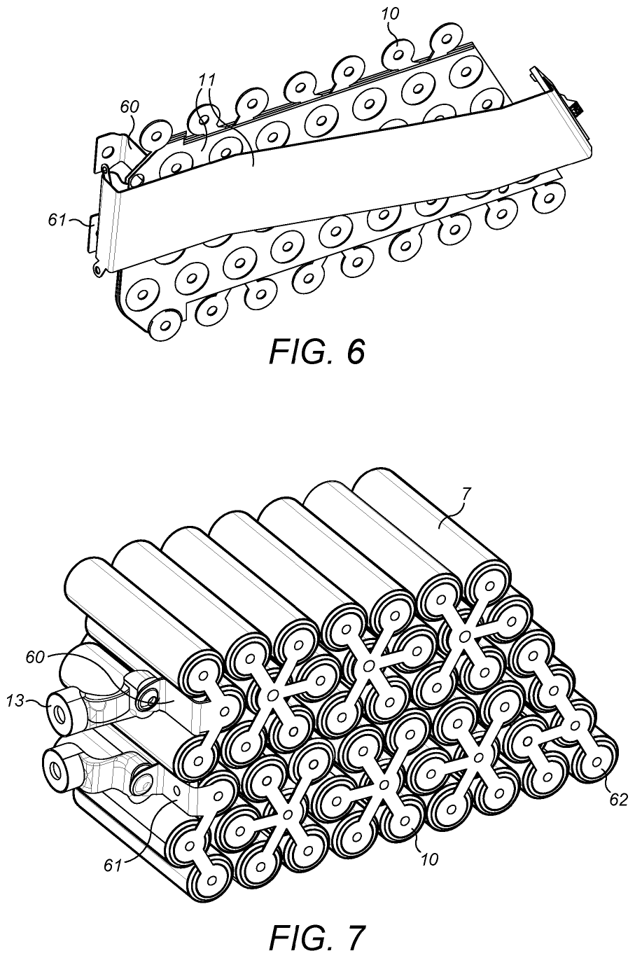

The busbars 10 may be integrated with a flexible printed circuit board (not shown in FIG. 7). FIG. 6 shows the flexible printed circuit board 11 of a battery module. A portion of the flexible printed circuit board 11 is located in the region enclosed by the module housing and another portion of the flexible printed circuit board 11 is wrapped around the exterior faces of both parts of the two-part module housing 3a, 3b, also shown in FIGS. 2 and 3.

The busbars 10 shown in FIGS. 6 and 7 may be integrated with the flexible printed circuit board 11. The busbars 10 may be configured to conduct a high level of current between the cells of the module and the module terminals 13.

The flexible printed circuit board 11 shown in FIG. 6 may further comprise sense wires. The sense wires may be configured to conduct a low current signal. The sense wires in the flexible printed circuit board may be attached to voltage sensors. Each voltage sensor may be capable of determining the voltage at a point on the busbar. Each voltage sensor may be capable of determining the voltage being drawn from a cell. Each voltage sensor may be capable of inferring the voltage being drawn from a cell from a measurement taken of the voltage being drawn from a busbar 10. Each sense wire in the flexible printed circuit board may be capable of communicating voltage measurements from a voltage sensor to a module control unit 12a, shown in FIG. 1. The module control unit 12a may be capable of adapting the activity of the battery module in response to the voltage measurements provided by the sense wire.

Each sense wire may be capable of communicating voltage measurements to the battery control unit. The module control unit 12a may be capable of communicating voltage measurements to the battery control unit. The battery control unit 12, also shown in FIG. 1, may be capable of adapting the activity of the battery module in response to the voltage measurements. The battery control unit 12 may be capable of adapting the activity of the battery in response to the voltage measurements.

The sense wires of the flexible printed circuit board 11 may be attached to one or more temperature sensors. A temperature sensor may be capable of determining the temperature of a part of the battery module. Each sense wire may be capable of communicating temperature measurements from a temperature sensor to the module control unit. The module control unit may be capable of adapting the activity of the battery module in response to the temperature measurements provided by the sense wire. Each sense wire may be capable of communicating temperature measurements to the battery control unit. The module control unit may be capable of communicating temperature measurements to the battery control unit. The battery control unit may be capable of adapting the activity of the battery module in response to the temperature measurements. The battery control unit may be capable of adapting the activity of the battery in response to the temperature measurements.

The sense wires may be attached to other types of sensors, for example current sensors, and/or fluid flow sensors.

FIGS. 6 and 7 also show terminal tabs 60, 61 which each of which connect either a positive or a negative end of the busbar to the respective positive or negative module terminal.

Module Cooling

It is known to supply coolant to regulate the temperature of batteries. In typical batteries, the coolant is confined within coolant jackets or pipes. In such batteries, cells are cooled in areas of the cell which make contact with the jacket or pipe containing the coolant. This is a slow and inefficient cooling method.

In other typical batteries, coolant is not confined by coolant jackets or pipes, but makes direct contact only with the body/centre portion of each cell. In such batteries, the cell terminals are protected so that coolant does not make contact with the cell terminals. Such contact is avoided as it would typically lead to electrical shorting. This is also an inefficient method because the cell terminals, being electrically connected, are often the hottest parts of the cell and yet they are not directly cooled by the coolant.

By contrast, in the battery module described herein, coolant supplied to the battery module 2 makes direct contact with cell terminals, flexible printed circuit board 11, busbars 10, and cell body. The entirety of the cell and connected conducting parts are bathed in coolant. The coolant used is a dielectric oil. Dielectric oils have insulating properties. Cells drenched in dielectric oil are insulated from one another preventing short circuiting between cells. This is an efficient method of regulating cell temperature. Such efficient cooling enables the cells to operate at a higher power and for longer. This means that fewer and/or smaller cells are required to generate the same power as batteries utilising the previously mentioned cooling methods.

FIG. 3 shows a supply coolant conduit portion 14 and a drain coolant conduit portion 15. In the exemplary configuration shown in FIG. 3, the supply coolant conduit portion 14 is positioned in a lower position and the drain coolant conduit portion 15 is positioned in an upper position. Such a configuration reduces the risk of air locks occurring during filling. Alternatively, the supply coolant conduit portion may be positioned in an upper position and the drain coolant conduit portion may be positioned in a lower position.

Both coolant conduit portions may extend along the battery module in a direction orthogonal to the longitudinal axis of the battery module. Both coolant conduit portions may extend along the battery module in a direction orthogonal to the direction in which the fixing hole 5 extends through the cell tray 4. Both coolant conduit portions may extend along the battery module in a direction parallel to the direction in which the cell holes 6 extend through the cell tray 4.

As shown in FIG. 3, the supply coolant conduit portion 14 is linked to an inlet 16 in the battery module so that coolant may be supplied to a region enclosed by the housing of the battery module. The drain coolant conduit portion 15 is linked to an outlet 17 so that coolant may be drained from a region enclosed by the housing of the battery module. Inlet 16 and outlet 17 are openings formed in the module housing. The coolant may be supplied to one of the two regions enclosed by the housing and be drained from the other of the two regions enclosed by the housing, one region being on an opposite side of the longitudinal axis of the cell tray to the other region. The cell tray 4 may comprise through-holes 35 to 40 for allowing the passing of coolant from a respective one of the said regions to the other of the said regions. The through-holes may be located in the cell tray 4 at the end of the cell tray 4 remote from the inlet 16 and outlet 17. The through-holes may be shaped to promote even fluid flow over the cells.

As shown in FIG. 1, battery 1 contains a number of battery modules 2 arranged in a row. When battery modules 2 are positioned in a row, a coolant conduit portion 14 of one battery module aligns with a coolant conduit portion of a neighbouring battery module. The two coolant conduit portions may be connected to one another by a coupler 19, shown in FIG. 3. Couplers 19 form liquid tight connections between coolant conduit portions so that coolant may flow from portion to portion. When supply coolant conduit portions 14 of the battery modules in the row of battery modules are connected by couplers 19, they form a supply coolant conduit 14a which extends along the length of the row of battery modules. When drain coolant conduit portions 14 of the battery modules in the row of battery modules are connected by couplers 19, they form a drain coolant conduit 15a which extends along the length of the row of battery modules.

As shown in FIG. 1, the longitudinal axes of all the battery modules 2 in the row of battery modules of the battery 1, may be parallel to one another. Both coolant conduits 14a, 15a may extend along the row of battery modules in a direction orthogonal to the longitudinal axes of the battery modules in the row of battery modules. Both coolant conduits may extend along the row of battery modules in a direction orthogonal to the direction in which the fixing hole 5 extends through the cell tray 4 of each battery module. Both coolant conduits may extend along the row of battery modules in a direction parallel to the direction in which the cell holes 6 extend through the cell tray 4 of each battery module.

Inlet 16 and outlet 17 may be configured to allow coolant to enter and leave the battery module 2. Inlet 16 and outlet 17 may further act as passages through which the flexible printed circuit boards 11 pass between the interior and exterior of the battery module, as shown in FIG. 3. The inlet 16 and outlet 17 may be the only openings in the two-part housing 3a, 3b of the battery module 2. FIG. 3 shows sealant 18 around the inlet 16 and outlet 17. Sealant 18 ensures that coolant inside the battery module does not leak from the battery module into other parts of the battery.

The method of direct cell cooling described herein also has further advantages in the case that excessive pressure builds up inside a cell. Each cell may comprise a cell vent port. In the case that excessive pressure builds up inside the cell, the cell vent port may be activated, allowing fluids within the cell to escape the cell. The cell vent port may be configured to expel cell fluids in the event that pressure within the cell exceeds a threshold. Upon leaving the cell, the fluids are quenched by the surrounding coolant.

Cell Tray—Further Details

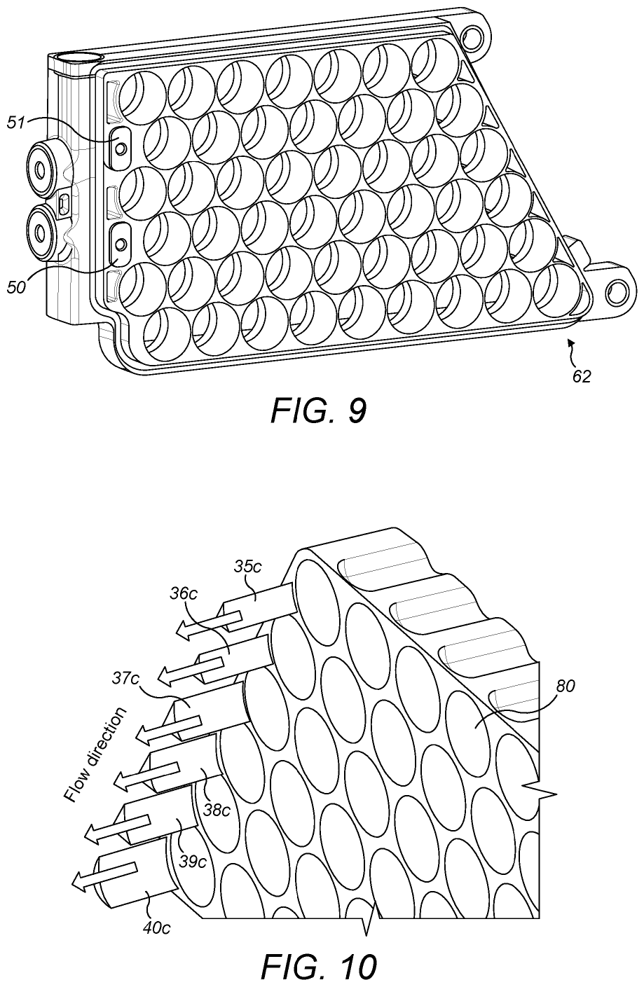

With further reference to FIGS. 4 and 5, as well as FIGS. 8 and 9, the cell tray 4 will now be described in further detail. The cell holes 6 are arranged in staggered rows, to maximise the number of cells that can be held in the tray. Each cell protrudes from each side of the cell tray 4, such that an exposed portion of the cell can be cooled by circulating coolant. Typically, less than half of the cylindrical outer surface of each cell is covered, preferably less than 25%, meaning that preferably at least 50% of the outer surface is exposed to coolant, more preferably over 75%. Each cell is typically held centrally within the cell tray, that is at or around the mid-point of the cell. This is the sturdiest location for the cells to be mounted as the cells are balanced in the cell tray and less stress is placed on the retaining elements (in this case resin and the cell tray). Off centre mounting of the cells may be possible, that is where one or more of the cells has a longer portion extending on one side of the cell tray than the other side. If this is done, it is preferable that all cells have the same offset as this makes the assembly process simpler.

The tray 4 has a first face 30 and second face 31. The first face 30 is provided with a recess 32. The recess is bounded by a wall 33, such that the ends of cell holes 6 on the first face are closer to a centre line of the tray than the wall 33. When battery cells are located in respective cell holes, resin can be inserted into the recess to secure the cells within the holes 6. Although not shown, the end of each cell hole may include, either as well as or instead of the recess 32, an individual cell recess into which resin can be inserted. The individual cell recess may be a stepped portion or may have a gradual change in shape.

Whilst the figures show a single recess 32 only on the first side 30 of the tray, a similar recess could be provided on the second side 31 instead of or as well as on the first side. Alternatively, one or both faces may have a plurality of recesses, each recess incorporating any number of cell holes. Alternatively, as shown in FIG. 9, the second face may contain no recess, such that the ends of the cell holes 6 are level and contiguous with the outer edge of the cell tray. FIG. 9 also shows the provision of a pair of terminals 50, 51 to which the cell busbars are connected. These terminals are located on the second face 31 of the cell tray, that is the side with no recess. One of these terminals is a positive terminal and one a negative terminal. The terminals 50, 51 are typically located on the inlet side of the cell tray, that is the side of the tray that receives incoming coolant flow. The recess may be located on either the inlet or the outlet side of the cell tray, although in the configuration shown, second face 31 is the inlet side.

The tray wall 33 includes arcuate recesses 34 which match to respective cell holes. Thus, whilst many of the battery cells will have resin around their entire circumference, some cells, typically those on the edges of the array of cells, will have resin only around a part of the circumference.

The tray 4 also comprises coolant flow holes 35 to 40. These coolant flow holes extend through the cell tray from one side to the other and are located at the opposite end of the cell tray to the inlet and outlet coolant flow. The coolant flow holes permit coolant to pass from one side to the other of the tray. The coolant flow holes are not intended to have a cell placed therein and are typically sized and/or shaped such that they are different from the cell holes 6, such that cell cannot fit therein. In this way, inlet coolant passes along one side of the tray, through the coolant flow holes, and outlet coolant then flows along the other side of the tray in substantially the opposite direction to the inlet coolant. It may be possible to replace the plurality of openings with a single opening which extends over a significant portion, at least 50% and preferably 75% or more, of the height of the cell tray, and in which the cross section of the opening increases in size towards the bottom of the opening.

As can be best seen in FIG. 8, the coolant flow holes 35 to 39 are bounded by the tray wall 33 and respective upper 35a to 39a and lower 35b to 39b arcuate wall sections. Coolant flow hole 40 is of a different shape to holes 35 to 39 due its location in the corner of the trapezoidal tray, and is bounded by the tray wall 33 and a single arcuate wall section 40a. Two or more of the flow holes may however have the same shape and/or size. These wall sections are substantially the same height from the centre line of the tray as the wall 33, thereby preventing resin from passing from the recess 32 into the coolant flow holes 35 to 40. They also prevent resin from passing around the entire circumference of a battery cell placed adjacent the wall sections.

The coolant flow holes 35 to 39 are therefore substantially triangular in shape, albeit with two arcuate sides. This shape is beneficial as it maximises the size of the flow holes for the particular configuration of the battery cells. Other shapes of flow holes could be used depending upon the cell holes configuration. For example, a circular shape hole is relatively easy to form, but may not be the most space efficient within the form of the cell tray. The coolant flow holes are larger at the bottom (in FIG. 4) than at the top. As the lower flow hole 39 is at the opposite end of the tray to the inlet and outlet flow (as shown in FIG. 3) and therefore the most distal corner of the tray to the inlet, this region can suffer from lower coolant flow than other regions. Therefore, the provision of larger flow holes with lower flow resistance encourages coolant flow into the more distal portions of the tray, and therefore more even cooling. For a differently shaped or oriented tray, larger flow holes could be located somewhere other than the lowermost corner, depending upon the shape of the array of cell holes.

FIG. 10 illustrate the form and shape of part of the region in which coolant flows within a module. Thus, FIG. 10 does not show the cell tray, cells or housing parts, but rather shows simply where the coolant would flow. Thus, holes 80 represent the locations of battery cells, so FIG. 10 shows clearly how the coolant flows around the outer surfaces of the individual cells and passes above, below and between the cells.

Sections 35c to 40c illustrate the flow through openings 35 to 40 within the distal end of the cell tray 4, the openings permitting the coolant flow to pass from one side to the other of the cell tray as shown in FIG. 10a. Thus, the battery module has, as shown in FIG. 10d, an inlet side 63 which receives fresh coolant and an outlet side 64 from which used coolant is expelled from the battery module, and the coolant flow follows a U-shape through the module. The openings are larger at the lower part of the module, meaning that flow resistance is lower, thereby encouraging coolant flow into the more distal regions of the module. Whilst a plurality of opening are shown, it may be possible to use a single elongate opening, where the upper end has a smaller cross section than the lower end, such that flow resistance is lower in the lower part of the battery module.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A battery cell tray comprising:
a main body having a plurality of holes extending therethrough from a first face to a second face,
a plurality of battery cells, each cell retained in a respective hole of the main body;
wherein each cell protrudes out of the main body on both the first and the second faces, further comprising one or more coolant flow openings within the cell tray to permit coolant flow to pass from one side of the cell tray to the other.

2. A battery cell tray according to claim 1, wherein the cells are supported by the cell tray substantially at the mid point of the cell.

3. A battery cell tray according to claim 1, wherein each cell has a pair of terminals, one at each end, and wherein the terminals of each cell are exposed.

4. A battery cell tray according to claim 1, wherein the cells are configured in a staggered pattern across the longitudinal plane of the cell tray.

5. A battery cell tray according to claim 1, wherein some cells have a reversed orientation with respect to other cells.

6. A battery cell tray according to claim 1, wherein a face of the main body has a recessed portion configured to receive a resin.

7. A battery cell tray according to claim 6, wherein the recessed portion extends around at least part of the end of a cell hole.

8. A battery cell tray according to claim 7, wherein multiple recessed portions are provided in a face, each recessed portion extending around at least part of the end of a respective cell hole.

9. A battery cell tray according to claim 7, wherein each cell hole has at least one recessed portion extending around at least part of an end of the hole.

10. A battery cell tray according to claim 7, wherein the recessed portion extends around the ends of a plurality of the cell holes.

11. A battery cell tray according to claim 7, wherein each recessed portion contains a resin for retaining the cells in the holes.

12. A battery cell tray according to claim 7, further comprising at least one recessed portion on each face.

13. A battery cell tray according to claim 7, wherein there is a step change between a cell hole and a respective recessed portion.

14. (canceled)

15. A battery cell tray according to claim 7, wherein the cells are supported by the cell tray substantially at the mid point of the cell.

16. A battery cell tray according to claim 7, wherein each cell has a pair of terminals, one at each end, and wherein the terminals of each cell are exposed.

17. A battery cell tray according to claim 7, wherein the cells are configured in a staggered pattern.

18. A battery cell tray according to claim 7, wherein some cells have a reversed orientation with respect to other cells.

19. A battery cell tray according to claim 1, further comprising a plurality of flow openings within the cell tray to permit coolant flow to pass from one side of the cell tray to the other.

20. A battery cell tray according to claim 19, wherein the flow openings are larger towards the most distal part of the housing.

21. A battery cell tray according to claim 19, wherein the or each flow opening is provided at one end of the cell tray.
